(19) United States
(12) Patent Application Publication
(10) Pub. No.: US 2013/0326927 A1
(43) Pub. Date: Dec. 12, 2013

(54) DEVICE TO FACILITATE DRY LAND, ROLL CASTING

(71) Applicant: Russell Allen Hershbarger, Nevada City, CA (US)

(72) Inventor: Russell Allen Hershbarger, Nevada City, CA (US)

(21) Appl. No.: 13/914,155

(22) Filed: Jun. 10, 2013

Related U.S. Application Data
(60) Provisional application No. 61/657,854, filed on Jun. 10, 2012.

(51) Int. Cl. A01K 97/00

(52) U.S. Cl. CPC A01K 97/00
USPC 43/4

(57) ABSTRACT

A device which holds a rigged fly stationary when initiating a cast with connected fly rod, line and leader but that then releases the rigged fly once acted upon by the action of the fly line and leader movement. This simulates the result of water tension to a degree sufficient to allow for both fly rod loading and complete leader turn-over. Thus, realistic roll casting practice in the absence of a body of water (on dry land) is made possible.

### CROSS-REFERENCE TO RELATED APPLICATIONS

This application claims the benefit of U.S. Provisional Application No. 61/657,854, filed Jun. 10, 2012.

### BACKGROUND OF THE INVENTION

The present invention is in the technical field of casting with a fly rod. More particularly the present invention is in the field of fly casting technics which depend upon water tension to provide resistance to fly line movement.

The Roll Cast, a standard type of fly casting and a component of Spey casting, is dependent upon surface tension between the fly line and water to allow for proper loading of a fly rod. It is thus difficult to practice in the absence of a sufficient surface area of water (either still water or moving water). To anchor the fly line on dry land the prior art has long used various attachments or covering weights (rocks, spring clamps, a human foot, etc.) as anchor points. While such treatments are effective in allowing the fly rod to load, they either completely prevent the leader from subsequently “turning over” or are dependent upon the error prone timing of human reaction to remove the anchor after the casting stroke but prior to the arrival of the “loop” such that the leader may then “turn over” unimpeded. The latter approach requires human assistance.

### SUMMARY OF THE INVENTION

The present invention is a device which, when used in conjunction with a standard fly rod, fly line and fly leader rigging, holds a rigged fly stationary under generally horizontal fly line tension force but releases it under generally vertical fly line tension. This allows for solo dry land casting practice, including leader “turn over”. Leader “turn over” as used herein refers to the freedom of the leader and attached fly to travel freely once acted upon by the movement of the leader and fly line. A rigged fly is one attached to the end of a leader, which itself is attached to the end of a fly line attached to a fly rod.

### BREIF DESCRIPTION OF THE DRAWINGS

FIG. 1 is a perspective view of a dry land roll cast facilitating device of the present invention.

FIG. 2 is a side view of the dry land roll cast facilitating device of FIG. 1.

FIG. 3 is a front view of the dry land roll cast facilitating device of FIG. 1.

FIG. 4 is a roll cast sequence view using the dry land roll cast facilitating device of the present invention

### DETAILED DESCRIPTION OF THE INVENTION

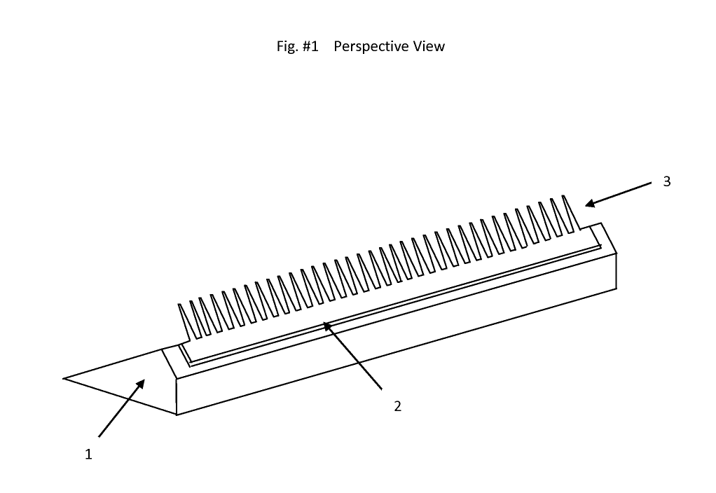

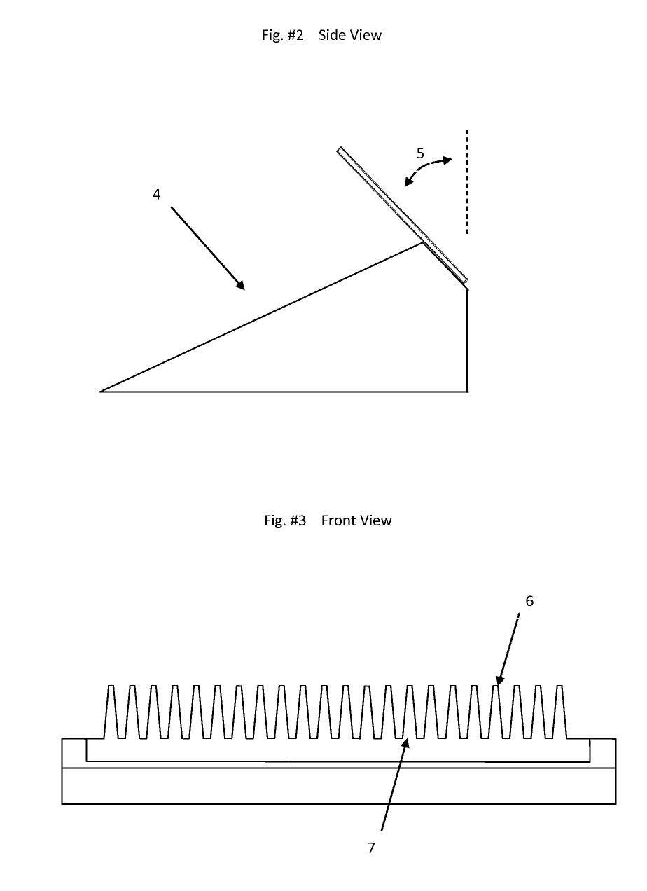

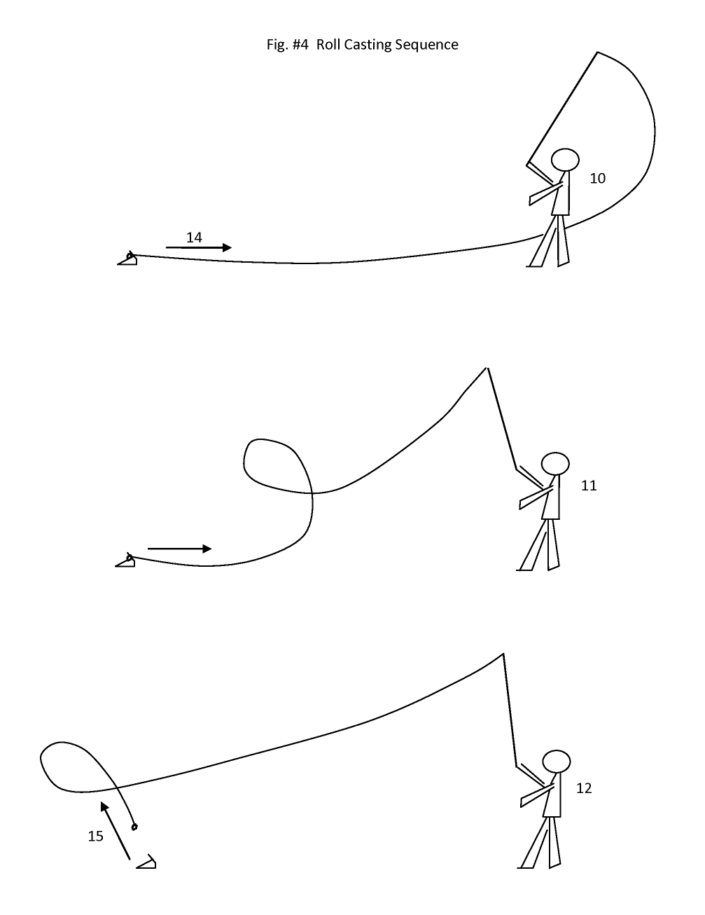

Referring to the invention in more detail, in FIGS. 1, 2 and 3 there is shown a device with base 1 and attached or incorporated plate 2. The plate 2 composed of a linear sequence of teeth 3 is held at an angle 5 relative to the perpendicular to the horizon by the base. The base surface behind the plate ramps in a continuous fashion to the back side of the teeth 3. The ramp 4 is substantially perpendicular to the plate 2.

The teeth 3 are shaped narrowly at the tip 6 and are shaped at their root 7 such that the space between them does not converge in a narrow manner such as a “V” but rather in an open manner such as a “U”, a box or square. The teeth must not converge in a narrow manner such as a “V” shape in that a rigged fly will then become entirely wedged, resisting removal in any direction. Convergence in an open manner, such as a “U”, shape is required. This allows the fly to be released in the generally vertical direction under the small force exerted by the fly line and leader loop but to be held in the generally horizontal direction under line tension from the fly rod, providing resistance and allowing the fly rod to be loaded.

The distance between the root 7 of adjacent teeth 3 must be greater than the diameter of the fly line but less than the thickness of the rigged fly. This allows the caster to set the fly by overhead casting above and across the teeth 3 allowing the fly line and/or leader to land and be positioned between the teeth 3. The fly line is then retrieved (pulled towards the caster) until the fly contacts the back side of the teeth. Here, the teeth block generally horizontal movement of the fly and, combined with the bulk of the base, provide resistance such that the fly rod may be loaded. A roll cast can thus be properly initiated. Once the resulting loop of the roll cast travels along the fly line and reaches the leader it exerts a force directed generally in parallel with the teeth. The teeth provide little resistance in this direction and the rigged fly and leader travel unimpeded. Subsequently, as long as the caster maintains the casted line trajectory within the extent of the teeth, a continuous sequence of these roll cast can be conveniently made.

The devices' inherent orthogonal hold-versus-release mechanism being oriented on true vertical and horizontal (plate 5 angle equaling zero degrees), is sufficient for longer casts but must be rotated such that plate is roughly perpendicular to the “fly-to-rod tip” trajectory. This accommodates shorter cast, as well, by reducing the risk of fly slippage. Alternate embodiments allowing for multiple plate angle adjustment can be envisioned.

The bulk of the apparatus leading into the teeth from the back needs to be smoothly ramped 4. Discontinuities here can result in the fly “bouncing-over” the teeth and failing to engage.

The whole device, base 1 and plate 2, must be of sufficient weight so as not to move under rod loading induced forces. Alternatively, the device may be itself anchored via external weight or stakes.

The length of the device and related number of teeth may be chosen for portability convenience. However, a novice caster will require a longer target (3 or 4 feet) compared to a skilled caster (1 to 2 feet) especially if the object is to insure that the line or leader fall within the teeth after each roll cast.

FIG. 4 demonstrates a Roll Cast sequence with caster 10 initiating a roll cast, caster 11 with the loop in transit to the device and caster 12 with the loop extracting the fly from the device.

The advantages of the present invention include, without limitation, that it mimics the resistive property of water tension on dry land by holding the fly during the initiation of a roll cast but that it then subsequently releases the fly once acted upon by the resulting casting loop and thus allow for the leader to turn over and fully extend as it would if actually casting upon water. Furthermore, it allows for roll pickup casts to be made.

In broad embodiment, the present invention is a device which holds a practice fly rigged to a fly rod with a standard leader and fly line stationary under generally horizontal fly line tension 14 but releases it under generally vertical fly line tension 15.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A device to aid roll casting on dry land, comprising a plate with a linear sequence of teeth, said teeth with adjacent spacing at their root greater than the diameter of a fly line but less than the width of a practice fly.

2. The device defined in claim 1, further comprising a base that supports the plate, wherein the plate is held at an angle from vertical.

3. The device defined in claim 2, further comprising a mass sufficient to resist movement when acted upon by a roll cast.

4. The device defined in claim 2, further comprising at least one attachment point to secure said device to the ground with at least one stake.

5. The device defined in claim 2, further comprising a ramp leading to the plate.
